(19) United States
(12) Patent Application Publication
(10) Pub. No.: US 2008/0055411 A1
(43) Pub. Date: Mar. 6, 2008

(54) External Monitoring System for Securing Driver's Field of Vision for Vehicles

(76) Inventor: Dong Wook Lee, Daejeon (KR)

Correspondence Address: AKERMAN SENTERFITT, P.O. BOX 3188, WEST PALM BEACH, FL, 33402-3188, US

(21) Appl. No.: 11/849,490

(22) Filed: Sep. 4, 2007

(30) Foreign Application Priority Data
Sep. 6, 2006 (KR) 10-2006-85797

(51) Int. Cl. H04N 7/18

(52) U.S. Cl. 348/148

(57) ABSTRACT

Disclosed therein is an external monitoring system, which includes cameras mounted at both sides of the front and rear of a vehicle and on side view mirrors, display devices for outputting images in a driver's front sight direction through the cameras, and controller for controlling the display devices. The display devices are mounted on a dash board of the upper portion of an instrument cluster or on the dash board of the upper portion of a steering wheel and are adjustable in their location laterally to allow the driver to gaze the front to the maximum. The external monitoring system includes: front and rear view cameras disposed at both side ends of the front and rear of the vehicle; side view cameras mounted on both side view mirrors of the vehicle in such a way as to be directed to the rear of the vehicle; at least two display devices for receiving and outputting signals inputted through the front and rear view cameras and the side view cameras; a holding device mounted on the dash board of the upper portion of the instrument cluster for moving the display devices laterally and fixing them; and a controller for converting the image output from the front and rear view cameras and the side view cameras and controlling brightness of a screen and zoom-in and zoom-out of the cameras.

### BACKGROUND OF THE INVENTION

1. Field of the Invention

The present invention relates to a monitoring system for monitoring images of the front and rear sides of a vehicle, and more particularly, to an external monitoring system for securing a driver's field of vision for vehicles, which includes a number of cameras respectively mounted on both sides of the front and rear of the vehicle and on side view mirrors, and a dual-display device mounted inside the vehicle for outputting images through the cameras, the dual-display device being mounted on a dash board of the upper portion of an instrument cluster and adjustable in its location in right and left directions to thereby aid the driver to gaze the front to the maximum.

2. Background Art

In this society, vehicles are the necessaries of life and the main factor of various accidents. So, various attempts to enhance safety in traveling the vehicles and reduce occurrence of accidents through development of technology have been making.

As an example of the technology, a sensor is mounted on the vehicle for allowing a driver to easily sense the width between the present vehicle and vehicles located in front of and in rear of the present vehicle, or small-sized convex mirrors are mounted on both side mirrors to remove a dead zone, which the driver cannot see.

So, recently, a monitoring system has been developed and used. The monitoring system includes a display device mounted in the inner space of the vehicle for outputting images of the front and the rear of the vehicle and a camera mounted on the outside of the vehicle, so that the driver can see things approaching the vehicle or the dead zone of the vehicle with naked eyes.

As a prior art, Korean Patent No. 475,960 discloses a rear monitoring system for vehicles.

The rear monitoring system includes rear view cameras 120 for viewing the rear of the vehicle, and so, side view mirrors are removed from the vehicle. The rear monitoring system further includes monitors 110 mounted at both sides of the inside of an instrument cluster 100 for allowing the driver to sense the rear images of the right and left sides of the vehicle, which are inputted through rear view cameras 120, when the driver gazes the instrument cluster 100.

However, when the monitors 110 are located inside the instrument cluster 100, the screens of the monitors 110 are hidden by a steering wheel or the driver's hand while the vehicle travels. In addition, since the driver directs his or her eyes to the instrument cluster 100 during a high-speed traveling, and so, a time period to watch the front is reduced. Finally, it may cause accidents since the driver cannot quickly grasp obstacles or other vehicles in front of the driver's vehicle. Furthermore, if the rear view cameras 120 are damaged or out of order, since the driver cannot sense conditions of the rear of the vehicles, it hinders a safe driving.

As described above, in general, the monitors, namely, the display devices of the conventional monitoring system are located at the center of the vehicle or the inside of the instrument cluster, and so, the driver can see the monitors by turning his or her head toward the center of the vehicle or toward the instrument cluster while traveling the vehicle.

So, since the driver has to gaze not only the front, a room mirror and the side mirror but also the display device located at the center of the vehicle, the time period to gaze the front of the vehicle is reduced, and so, it may hinder the safe driving. In addition, recently, since the number of vehicles, in which navigation devices are mounted for the driver's convenience, is increased, the driver directs his or her eyes also to the navigation device, the time period to gaze the front of the vehicle is more reduced.

To solve the above problem, the display device is located inside the instrument cluster, but it has several problems in that the screen of the display device is frequently hidden by the steering wheel of the vehicle, and in that a field of vision cannot be sufficiently secured for the front traveling since the driver directs his or her eyes toward the instrument cluster.

Meanwhile, lenses of the cameras mounted on the outside of the vehicle are deteriorated in an image-sensing rate due to a temperature drop in the rainy season in summer or in the wintertime, and thereby, the driver cannot exactly check the outside conditions through the display device.

### SUMMARY OF THE INVENTION

Accordingly, the present invention has been made to solve the above-mentioned problems occurring in the prior arts, and it is an object of the present invention to provide an external monitoring system for securing a driver's field of vision for vehicles, which can fix a driver's eyes to the front and allow the driver to sense conditions of the front and rear sides of the vehicle through a dual display device mounted near to the driver's front sight.

It is another object of the present invention to provide an external monitoring system for securing a driver's field of vision for vehicles, which can freely control an angle of a side camera mounted on a side mirror to thereby remove a dead zone during traveling, and which can fold side mirrors during a high-speed traveling to thereby reduce resistance of the air and sense conditions of the left and right sides of the vehicle.

It is a further object of the present invention to provide an external monitoring system for securing a driver's field of vision for vehicles, which includes cameras mounted at both side ends of the front and rear of the vehicle and on both side view mirrors to allow the driver to grasp conditions of the front, rear and both sides of the vehicle, and additional devices mounted on the cameras to prevent the cameras from being deteriorated in efficiency of image output due to natural environments.

To accomplish the above object, according to the present invention, there is provided an external monitoring system for securing a driver's field of vision for vehicles comprising front and rear view cameras mounted at both side ends of the front and rear of a vehicle body, and side view cameras mounted on both side view mirrors in such a way as to be directed backwardly.

Meanwhile, the external monitoring system according to the present invention further includes: display devices for receiving signals inputted through the front and rear view cameras and the side view cameras and outputting images; and a holding device mounted on a dash board of the upper portion of an instrument cluster of the vehicle for fixing the display devices after moving them in right and left directions. Here, the holding device is detachably mounted on the dash board in case of the existing delivered vehicles or old model vehicles.

In addition, the external monitoring system according to the present invention further includes a controller for converting the image output from the front and rear view cameras and the side view cameras and controlling brightness of a screen and zoom-in and zoom-out of the cameras.

Meanwhile, the side view cameras can be rotated by a direction-adjusting switch of the controller.

Moreover, the front and rear view cameras and the side view cameras respectively include auxiliary visible and infrared ray lighting devices, and hot wire devices for preventing freezing.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a configurative view showing a rear monitoring camera according to the prior art;

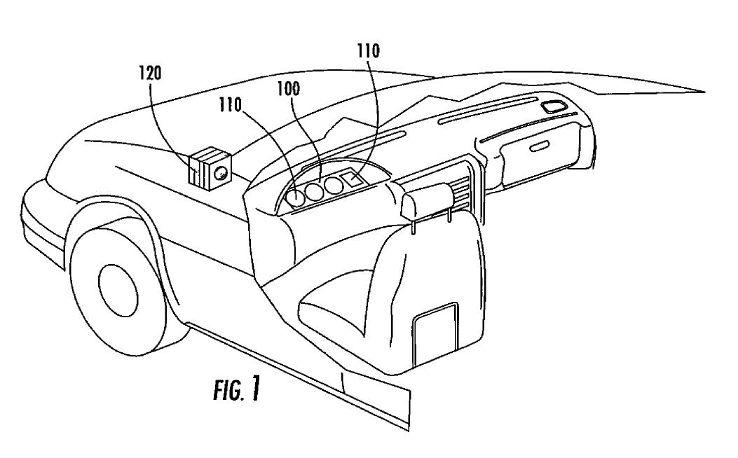

FIG. 2 is a configurative view of an external monitoring system for securing a driver's field of vision for vehicles according to the present invention;

FIG. 3 is a plan view of the vehicle to which the external monitoring system according to the present invention is applied;

FIG. 4 is a view showing the inside configuration of the vehicle to which the external monitoring system according to the present invention is applied;

FIG. 5 is a front view of a side view camera of the external monitoring system according to the present invention; and

FIG. 6 is side view of a holding device of the external monitoring system according to the present invention.

### DETAILED DESCRIPTION OF THE PREFERRED EMBODIMENT

Reference will be now made in detail to the preferred embodiment of the present invention with reference to the attached drawings.

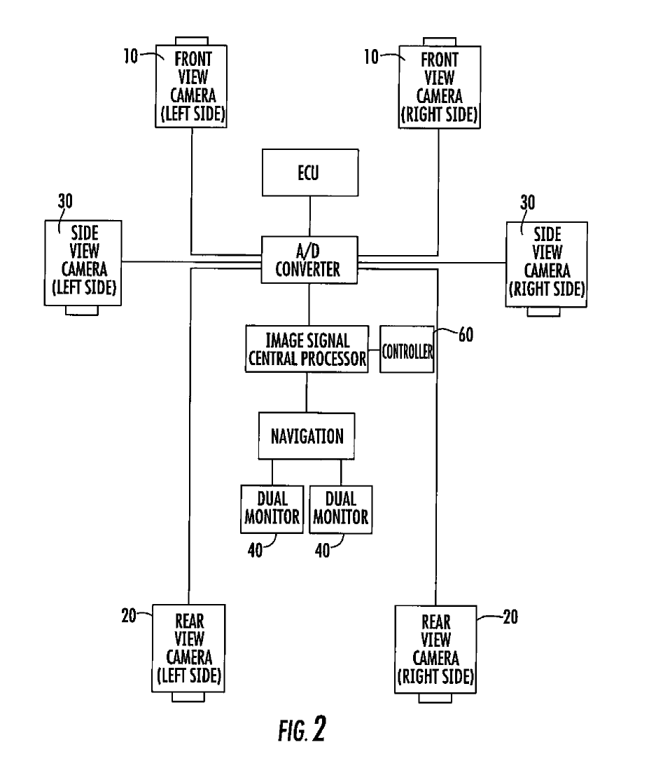

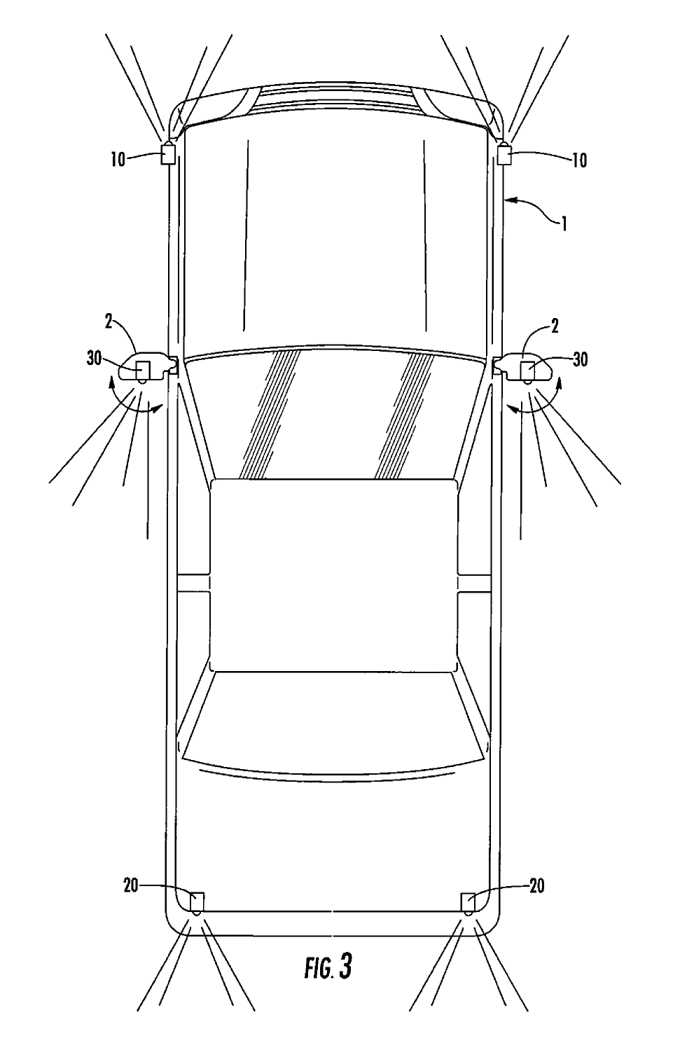

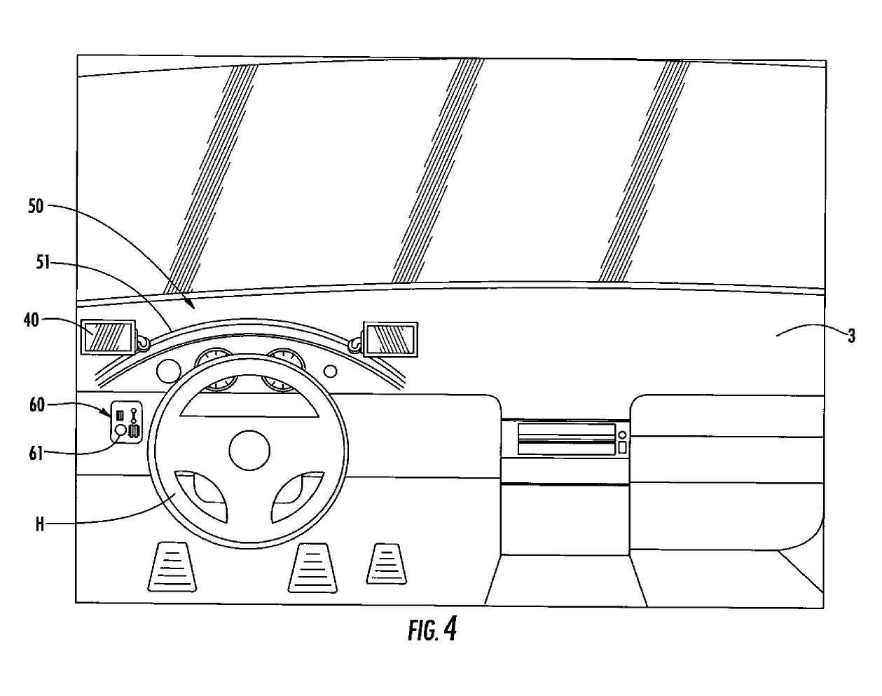

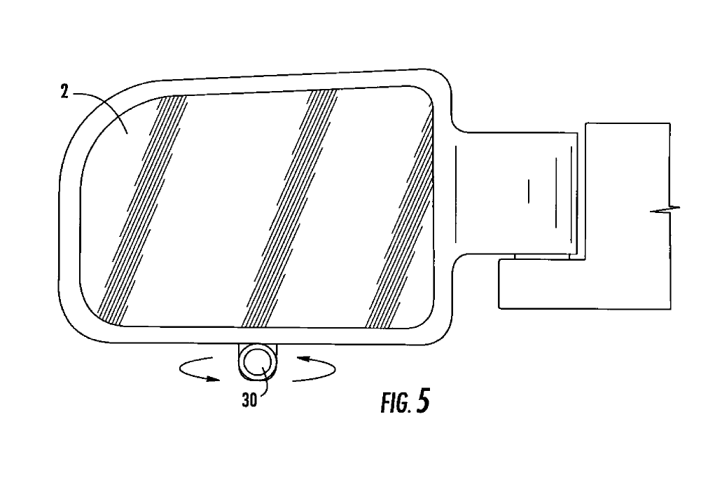

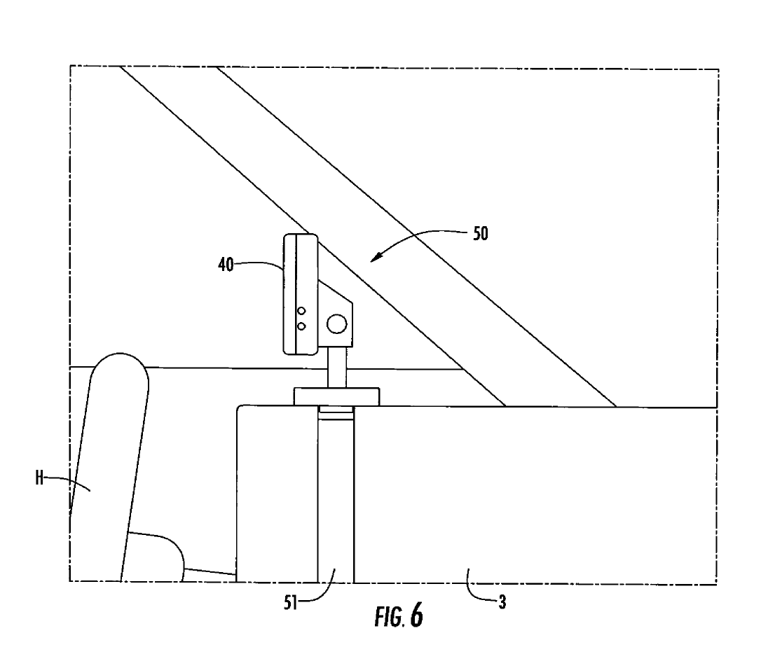

FIG. 2 is a configurative view of an external monitoring system for securing a driver's field of vision for vehicles according to the present invention, FIG. 3 is a plan view of the vehicle to which the external monitoring system according to the present invention is applied, FIG. 4 is a view showing the inside configuration of the vehicle to which the external monitoring system according to the present invention is applied, FIG. 5 is a front view of a side view camera of the external monitoring system according to the present invention, and FIG. 6 is side view of a holding device of the external monitoring system according to the present invention.

The monitoring system having a number of cameras mounted on the outside of a vehicle for monitoring the outside conditions of the vehicle includes front and rear view cameras 10 and 20 mounted at right and left side ends of the front and rear of a vehicle body 1 as shown in FIG. 2 like the conventional cameras, and side view cameras 30 mounted on both side view mirrors 2 of the vehicle in such a way as to be directed to the rear of the vehicle. Here, the front and rear view cameras 10 and 20 and the side view cameras 30 respectively include additional devices, such as auxiliary visible and infrared ray lighting devices, and hot wire devices for preventing freezing. Here, the side view cameras 30 are rotated at a predetermined angle in the right and left directions according to the driver's manipulation.

In the meantime, the monitoring system further includes a pair of separate-type display devices 40 for receiving and outputting image signals of the right and left sides inputted through the front and rear view cameras 10 and 20 and the side view cameras 30. Each display device 40 is mounted on a dash board 3 located on the upper portion of an instrument cluster of the vehicle, and includes a holding device 50 for adjusting and fixing the display device 40 in right and left directions and in upper and lower directions. The holding device 50 is detachably mounted on the dash board 3 in case of the previously delivered vehicles or old model vehicles, but is manufactured in advance through a production process in case of new vehicles.

Moreover, the monitoring system further includes a controller 60 for converting an image output from the front and rear view cameras 10 and 20 and the side view cameras 30 and adjusting brightness of a screen and zoom-in and zoom-out of the cameras. The controller 60 has a direction-adjusting switch 61 to rotate the side view cameras 30 at a predetermined angle in a side direction.

Meanwhile, the rear view cameras 20 are adapted in such a way that an image to be displayed on a screen is automatically converted into an image from the rear view camera due to a location of a gear and the converted image is outputted to the display device when the vehicle travels backwardly. In addition, the side view mirrors 2 are automatically collapsibly folded and the side view cameras 30 are automatically adjusted in their angles in such a way as to direct backwardly when the traveling speed of the vehicle is increased. In addition, the display device 40 may further include an external input terminal so that it can be used as a monitor for a navigation device mounted inside the vehicle.

The unexplained reference sign “H” designates a steering wheel of the vehicle.

As described above, as shown in FIG. 3, the monitoring system includes the front and rear view cameras 10 and 20 mounted at both side ends of the front and the rear of the vehicle, and the side view cameras 30 mounted on the bottom surface of the both side view mirrors 2. When the driver selects some images of the images from the plural cameras at the driver's discretion, the monitoring system outputs two screen images to the display device 40.

The image output of the display device 40 is basically achieved by a one-touch manipulation of the controller 60, but the screen can be converted according to a voice signal, which is previously stored, by a voice-recognizing system mounted inside the controller 60.

When the driver selects the screen outputting the image through the display device 40, the driver can adjust zoom-in and zoom-out of the cameras, brightness of the screen and angles of the cameras through various switches of the controller 60.

Particularly, since the controller 60 has the direction-adjusting switch 61 for removing the dead zones of predetermined ranges at the right and left sides of the vehicle by rotating the side view cameras 30 at the predetermined angle, the present invention can effectively remove the side dead zones during traveling or parking.

An actually used state of the cameras 10, 20 and 30 will be described in more detail. When the driver changes a traffic lane to the right or left side while traveling the vehicle, it is important to grasp distances among vehicles located by the sides and in front and rear of the present vehicle. So, through the monitoring system according to the present invention, the driver can check the distances among the vehicles located side by side through the front and rear view cameras 10 and 20, and check whether or not there is any vehicle located in the dead zone using the side view cameras 30.

Moreover, when the driver parks the vehicle at night, the driver can easily secure the driver's field of vision to park the vehicle at night by the lighting device, which interlocks with the rear view and side view cameras 20 and 30 and is mounted in such a way as to light the wheels of the vehicle.

Meanwhile, when the driver parks the vehicle, the driver can check intervals of the right and left sides of the vehicle through the rear view camera 20, and the distances among the vehicles located side by side by outputting the images from the side view cameras 30 to the display device 40 at a fixed interval in turn. For this, as one of the additional devices, the monitoring system further includes a switching device for outputting the images transferred from the right and left sides and the front and rear sides to the display device 40 at the fixed interval in turn.

When the angles of the side view cameras 30 are adjusted during traveling and parking, as shown in FIG. 5, the angles of the cameras are memorized and set, and so, the angles of the side view cameras 30 can be automatically adjusted to the previously set angle without additional adjustment. As an example of the automatic angle adjustment, when the traveling speed of the vehicle exceeds a predetermined speed, the side view mirrors 2 are automatically collapsibly folded to reduce resistance of the air when vehicle speed information is received from an ECU and the vehicle speed exceeds the previously set speed. In this instance, it would be appreciated that the side view camera 30 located on the bottom surface of the side view mirror 2 can serve as the side view mirror 2 by being changing its angle.

The angle of the side view camera 30 can be automatically adjusted according to conditions of the vehicle, such as traveling or parking, by the driver's one-touch manipulation after the driver previously sets wanted several angles of the side view camera 30.

Meanwhile, the display device 40 is mounted and fixed on the dash board 3 of the upper portion of the instrument cluster of the vehicle in such a way that the driver can direct his or her eyes to the front to the maximum. As shown in FIG. 6, the display device 40 can be produced in such a way that the holding device 50 comprising a rail 51 or fixing device having a fixed lateral length is mounted and fixed on the dash board 3 or that the rail or the fixing device having the fixed lateral length is formed on the upper portion of the dash board of the vehicle, which is not yet delivered.

The holding device 50 can move the two display devices 40 laterally through the rail 51 or the fixing device, and fix the display devices 40 at the driver's wanted locations to thereby easily secure a field of vision for traveling the vehicle.

Furthermore, through the dual display devices 40, the image from the left view camera is outputted to the left display device and the image from the right view camera is outputted to the right display device, whereby the driver can easily grasp the location relation among the corresponding images and the location of the present vehicle.

Meanwhile, since the display device 40 has the external input terminal, additional device requiring a display device, such as the navigation device, can be additionally connected to the display device 40 and output an image to the display device 40, whereby the inside space of the vehicle can be effectively used.

Moreover, additional devices, such as auxiliary visible and infrared ray lighting devices for preventing freezing of lenses due to a temperature drop at night, in the rainy season and the winter season, a hot wire device for preventing freezing, and so on, are mounted on the front and rear view cameras 10 and 20 and the side view cameras 30 to thereby always supply the driver with high-quality images.

Meanwhile, it is preferable that the plural cameras 10, 20 and 30 are all finely adjusted in right and left directions and in upper and lower directions to allow the driver to obtain a wanted screen.

As described above, the display devices 40 are located on the dash board of the upper portion of the instrument cluster of the vehicle to previously prevent various accidents occurring when the driver turns his or her head to the right or left sides to check the sides or dead zone of the vehicle during traveling. The display devices 40 are moved laterally in such a way as to be adjusted to the driver's wanted location. In addition, the cameras mounted on the front and rear view mirrors and the side view mirrors of the vehicle are controlled by the controller 60, so that the driver can easily adjust brightness of the screen, zoom-in and zoom-out and the turning angles of the cameras, and so on.

As described above, the external monitoring system for securing the driver's field of vision according to the present invention can aid the driver's safe driving, since it makes the driver fix his or her eyes to the front of the vehicle and sense conditions of the front and rear sides of the vehicle through the dual display device mounted on the dash board near to the driver's front sight direction during all traveling states of the vehicle (forward traveling, backward traveling, right and left rotations, and so on). In addition, the external monitoring system according to the present invention can remove the dead zone occurring during traveling or parking since the angles of the side view cameras mounted on the side view mirrors can be freely adjusted.

Moreover, the external monitoring system according to the present invention can always output the high-quality image information without deterioration of the images due to natural environments, since various additional devices are mounted on the cameras disposed at both front and rear side ends of the vehicle to allow the driver to check the front and rear sides of the vehicle even at night or in nasty weather.

The external monitoring system according to the present invention can be usefully applied to high-speed sports cars or vehicles, which frequently travel at high speed, and effectively help unskilled drivers to gaze the front without deviation in gaze during traveling and parking.

When the existing side view mirrors are completely removed and only the side view cameras are mounted at the side view mirrors' positions, the present invention can solve the problem of the conventional monitoring system that the driver's field of vision is not secured due to a trouble of the cameras.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. An external monitoring system for securing a driver's field of vision for vehicles, which includes a number of front and rear view cameras mounted on the outside of the vehicle, comprising:
side view cameras disposed on both side view mirrors of the vehicle and directing the rear of the vehicle;
a pair of multi-functional display devices for receiving signals inputted through the front and rear view cameras and the side view cameras and outputting images, the display devices being mounted in a driver's gaze direction located on a dash board of the upper portion of a steering wheel or on the upper portion of an instrument cluster of the vehicle;
a holding device for holding and fixing the display devices and adjusting the display devices in right and left directions and in upper and lower directions; and
a controller for controlling the images from the front and rear view cameras and the side view cameras and a camera manipulation.

2. The external monitoring system according to claim 1, wherein the display devices are two mounted at right and left sides of the vehicle, the image from the left side camera being outputted to the left display device and the image from the right camera being outputted to the right display device, the display device being detachably mounted on the dash board of the upper portion of the instrument cluster or the dash board of the upper portion of the steering wheel in case of existing delivered vehicles or old model vehicles, and being adjustable in right and left directions and in upper and lower directions.

3. The external monitoring system according to claim 1, wherein the side view cameras are rotated by a direction-adjusting switch of the controller at a predetermined angle in a side direction.

4. The external monitoring system according to claim 1, wherein the plural front and rear view cameras and the side view cameras respectively include auxiliary visible and infrared ray lighting devices, and hot wire devices for preventing freezing.

5. The external monitoring system according to claim 1, wherein the rear view cameras are adapted in such a way that an image to be displayed on a screen is automatically converted into an image from the rear view camera due to a location of a gear and the converted image is outputted to the display device when the vehicle travels backwardly.

6. An external monitoring system for securing a driver's field of vision for vehicles, wherein side view mirrors disposed at both sides of the vehicle are automatically collapsibly folded and side view cameras disposed on both of the side view mirrors are automatically adjusted in their angles in such a way as to be directed in the backward direction when a traveling speed of the vehicle received from an ECU of the vehicle exceeds a previously set speed as the traveling speed of the vehicle is gradually increased.

7. The external monitoring system according to claim 1, wherein the display device includes an external input terminal so that the display device can be used as a monitor of a navigation device mounted inside the vehicle.
